(19) United States
(12) Patent Application Publication
(10) Pub. No.: US 2002/0032114 A1
(43) Pub. Date: Mar. 14, 2002

(54) Combustion synthesis of glass (Al2O3-B2-O3-MgO) ceramic (Tib2) composites

(76) Inventors: Hu Chun Yi, St. John's (CA); Jacques Y. Guigne, Paradise (CA); John J. Moore, Evergreen, CO (US)

Correspondence Address: Timothy T. Tyson, Freilich, Hornbaker & Rosen, Suite 1220, 10960 Wilshire Blvd., Los Angeles, CA, 90024, US

(21) Appl. No.: 09/859,755

(22) Filed: May 16, 2001

Related U.S. Application Data
(63) Continuation of application No. 09/351,227, filed on Jul. 12, 1999.

(51) Int. Cl. C03C 14/00; C03C 10/02; C03C 11/00

(52) U.S. Cl. 501/32; 501/39; 501/10

(57) ABSTRACT

In-situ formation of a series of glass-ceramic composites by the Self-propagating High temperature Synthesis (SHS) technique. Advantages include processing simplicity and cost savings. The materials processed by the technique either have a pure glassy matrix (Al₂O₃—B₂O₃—MgO) or a glass matrix with partial devitrification, and crystalline TiB₂ particles having a size of about 0.5 μm. The material can be prepared either in inert atmosphere inside a reaction chamber or in air without a chamber. The materials exhibit relatively high porosity and good strength and can be used as filters, thermal insulation materials or in other similar applications.

### CROSS REFERENCE

This application is a continuation in part of U.S. application Ser. No. 09/351,227 filed Jul. 12, 1999.

### BACKGROUND OF THE INVENTION

The present invention relates to the field of composites and more particularly to composites which are a mixture of TiB₂ particles in a glass matrix or a glass matrix with areas of devitrification. This invention also relates to novel methods of manufacturing such composites.

This invention uses a novel technique to produce glass-ceramic composites at lower costs than the traditional processing techniques. The new glass-ceramic composites exhibit high porosity and find applications as filters, thermal insulation materials, and others requiring light weight.

Glasses exhibit superior properties such as high wear and corrosion resistance. The traditional technique of manufacturing these materials involves fusion of the constituent oxides followed by shaping to desired shapes. The glass formation of the aluminoborates of Group II metal oxides was studied before using the traditional technique [Hirayama, J. Am. Ceram. Soc., vol. 44, No.12 (1961), pp. 602-606]. Those glasses have softening points in the range of 450-600° C., and linear thermal expansion coefficients 4.7×10⁻⁶ to 16×10⁻⁶ per ° C.

The application of the Self-propagating High Temperature Synthesis (SHS) technique to produce various materials has been demonstrated in a number of review articles. In this invention, the Self-Propagating High Temperature Synthesis (SHS), or Combustion Synthesis has been used to produce these glasses. The SHS is a novel technique to produce many advanced materials [Moore and Feng, Progress in Materials Science, Vol. 39, 243-316 (1995); Munir and Anselmi-Tamburini, Materials Science Reports, vol.3, 277-365 (1989), Yi and Moore, J. Mater. Sci., vol. 25, 1159-1168 (1990).]. Simply speaking, the technique uses reactant powders to form a green pellet which is then ignited by an external heat source to generate chemical reactions, producing the end product in-situ. The SHS process can be realized by two modes, i.e., propagation (or combustion) mode and simultaneous (or thermal explosion) combustion mode. In the propagation mode, the reactants are ignited by an external heat source. Once ignited, the highly exothermic reaction ignites the next adjacent reactant layer by itself thereby generating a self-sustaining wave propagating toward the unreacted part. In the simultaneous combustion mode, all reactants are heated uniformly until the combustion reaction is initiated simultaneously throughout the whole pellet. A combustion reaction is defined by mainly three parameters: ignition temperature, which is the temperature at which the reaction rate becomes appreciable and self-sustaining; combustion temperature, which is the maximum temperature achieved; and the combustion wave velocity which is the overall combustion rate. However, the state of green reactants, (i.e. particle size, green density, reaction environment, etc.) has a profound influence on combustion.

SHS has the following advantages compared to the traditional routes (such as Powder Metallurgy):

(i) energy saving since a high temperature furnace is not required;

(ii) time saving since the typical combustion velocity ranges from a few millimeters to a few centimeters per second and the whole process lasts a short period of time;

(iii) relative high purity of the final product since the high combustion temperature vaporizes most impurities; and

(iv) simplicity of the whole process.

Because of these advantages, materials produced by SHS have a lower overall cost compared to conventional routes.

The inventors have previously synthesized a series of glass ceramic composites based on Al₂O₃—B₂O₃—BaO glasses using the SHS technique [Yi et al, U.S. Pat. No. 5,792,417]. This invention is a further continuation which reveals processing of another series of glass-ceramic composites based on Al₂O₃—B₂O₃—MgO glasses using an improved approach. These materials have a higher degree of porosity and, at the same time, exhibit good strength.

Development of a TiB₂/Al₂O₃—B₂O₃—MgO glass-ceramic composite and a low cost method of producing it represent great improvements in the field of composites and satisfy a long felt need of the composite engineer.

### SUMMARY OF THE INVENTION

The present invention uses powder reactants as raw materials. The powders are weighed according to the desired composition and thoroughly mixed by ball milling. Pellets with varied green densities (typically 34-60% theoretical) are pressed or packed from the mixed powders. Some green pellets are then further heat treated to increase their rigidity, thus making them easier to handle. Final products are synthesized by igniting the heat treated pellets, thus establishing a self-sustaining combustion reaction until the whole pellet is reacted.

The combustion reactions are either ignited by the propagation or simultaneous combustion mode. In the case of the propagation mode, the pellet is ignited at one end either in an inert atmosphere inside a chamber or in air without a chamber, and the combustion proceeded in a self-sustaining way. The combustion temperatures (Tc) are in the range of 1200-1600° C. and wave velocities are in the range of 1-6 mm/s depending on the conditions such as green density, particle size and compositions. In the case of the simultaneous combustion mode, the whole pellet is heated inside a furnace heated to 700-900° C. until the combustion reaction is initiated. Neither the combustion temperature nor the wave velocity have been determined for this case, but they should be higher than those generated by the propagation mode. Pellets are withdrawn from the furnace immediately after the combustion reaction is completed.

The green density of pellets has a great influence on combustion characteristics. As the green density increases, both the combustion temperature and wave velocity decrease with the velocity decline more drastic. Pellets with high green density (e.g., >50%) are difficult to ignite and the combustion waves self-quench in some situations, while those with lower green density (e.g., <40%) are readily ignited with minimum preheating before combustion and the combustion reaction proceeds to completion for all samples.

The final products of this invention have a relatively high degree of apparent porosity (52-58%) and overall porosity (66-70%). This makes useful for applications as filters and thermal insulation materials.

The materials of invention either have a pure glass matrix, or a glass matrix with partial devitrification, and a crystalline TiB₂ phase. Both the relative amount of the glass matrix in the composite and the composition of the glass matrix itself can be varied.

X-ray diffraction (XRD) and Scanning Electron Microscopy (SEM) have confirmed that glass-ceramic composites were obtained. The TiB₂ phase (fine particulate form) having a typical size less than 0.5 μm, was the only crystalline phase (apart from devitrifed phases) dispersed in the glassy matrix. The size of the TiB₂ was dependent on the composition but generally was less than 0.5 μm.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is a typical temperature profile during the combustion synthesis of a pellet with glass matrix composition of 40B₂O₃-35MgO-25Al₂O₃ and green density of 34%.

FIG. 2 is a graph illustrating the effect of green density on combustion temperature.

FIG. 3 is a graph illustrating the effect of green density on velocity of wave propagation.

### DETAILED DESCRIPTION OF THE PREFERRED EMBODIMENT

The processing procedure includes the following steps: (1) mixing the reactant powders; (2) preparation of the green pellets with desired density; and (3) igniting the green pellet to generate self-sustaining combustion waves. The reactants powders used are listed in Table 1. The preferred particle size is less than 45 μm.

TABLE I
Specifications of the Reactant Powders

| Reactants | Particle Size, m | Impurity, % | Vendors |
|---|---|---|---|
| Al | <44 | <0.5 | AlfaAesa |
| B₂O₃ | <44 | <0.5 | AlfaAesar |
| Mg | <44 | <0.4 | Cerac |
| TiO₂ (Rutile) | <44 | <0.5 | Cerac |

The mixture of the reactant powders is carried out according to the following chemical reactions:

αTiO₂+(α+x)B₂O₃+2βAl+γMg→αTiB₂+βAl₂O₃+x B₂O₃+γMgO+Q→=αTiB₂+βAl₂O₃.xB₂O₃·γMgO (1)

where Al and Mg reduce TiO₂ and B₂O₃ forming TiB₂, Al₂O₃, and MgO. The heat (Q) released in the process was high enough to melt the products, forming a glass melt (βAl₂O₃·χB₂O₃·γMgO), and to sustain a self-propagating combustion wave. The glass melt may stay in amorphous state or undergo partial devitrification depending on the composition, cooling rate, and other factors. The relative amount of oxides in the glass matrix are adjusted by the coefficients χ, β, and γ. In equation (1), β can be any finite number and α, γ and χ are determined by the following three equations:

$$α = \frac{1}{5} ( 3 β + γ ) \qquad ( 2 )$$

$$γ = β \frac{{f}_{m}}{{f}_{a}} \\ χ = β \frac{{f}_{b}}{{f}_{a}} \qquad ( 3 )$$

where fₘ, fₐ, and f_{b} represent the molar percentages of MgO, Al₂O₃ and B₂O₃ in the matrix (that is excluding the TiB₂) of the product respectively. For example, to produce a sample containing a matrix composition of 40%B₂O₃·35%MgO·25%Al₂O₃, if β is chosen as 25, then α=22, γ=35 and χ=40. Although numerous tests have been conducted, no upper limit of β has yet been experienced. Testing has been performed with β=10⁻³⁰⁰ and β=10³⁰⁰ and the results are 40%B₂O₃·35%MgO·25%Al₂O₃. Examples of various compositions are given in Table 2. The corresponding adiabatic temperatures calculated for these compositions are also listed in Table 2.

The TiB₂/Al₂O₃·B₂O₃·MgO composites produced by equation (1) represent one of two improvements over the last invention by the same authors [Yi et al. U.S. Pat. No. 5,792,417]. In that patent, the same composites were produced by different combustion reactions which were less exothermic. The second improvement was the technique developed to fabricate the low density pellets revealed in this invention.

TABLE 2
Compositions (Mol. %) and Adiabatic Temperatures
(Tad) of Selected Glass-ceramic Composites
Produced by the Combustion Reaction of Equation (1)

| Compositions (mol. %) | χ | α | β | γ | T_{ad}, ° K |
|---|---|---|---|---|---|
| 40 B₂O₃-40MgO-20 Al₂O₃ | 2 | 1 | 1 | 2 | 1967 |
| 50 B₂O₃-30MgO-20 Al₂O₃ | 25 | 9 | 10 | 15 | 1707 |
| 40 B₂O₃-45MgO-15 Al₂O₃ | 40/3 | 6 | 5 | 15 | 1911 |
| 40 B₂O₃-30MgO-30 Al₂O₃ | 20/3 | 4 | 5 | 5 | 2063 |
| 45 B₂O₃-40MgO-15 Al₂O₃ | 45 | 17 | 15 | 40 | 1772 |
| 45 B₂O₃-35MgO-20 Al₂O₃ | 45 | 19 | 20 | 35 | 1834 |
| 35 B₂O₃-45MgO-20 Al₂O₃ | 35 | 21 | 20 | 45 | 2104 |
| 40 B₂O₃-35MgO-25 Al₂O₃ | 40 | 22 | 25 | 35 | 2017 |
| 35 B₂O₃-40MgO-25 Al₂O₃ | 35 | 23 | 25 | 40 | 2148 |

The process starts with weighing and thoroughly mixing the reactant powders according to the desired compositions using ball milling, dry, in air. Actual mixing time depends on the amount of powders to be mixed. Green pellets are then prepared either by pressing the mixed powders uniaxially to densities of 55-70% theoretical or by a method described later to densities of 30-50% theoretical. Green pellets are ignited using one of the three methods: 1) by resistance heating a W coil in an inert atmosphere inside a reaction chamber, 2) by resistance heating a Kanthal-wire in air without a reaction chamber; or 3) by burning of a regular torch in air without a chamber. Kanthal is a series of iron-chromium-aluminum electrical resistance alloys, available in wire, strip and other forms with a variety of maximum operating temperatures. Kanthal is a registered trademark of Kanthal AB, Sweden with offices in Bethel, Conn.

Temperature profiles during the combustion reaction for selected samples were recorded by a data acquisition system. Two C-type thermocouples (W-5%Re/W-26%Re) of 5 mil diameter (welded under flowing argon atmosphere) were used. The thermocouple signals were amplified using an instrumentation amplifier. Finally, a video recording system consisting of a color camera with macro-zoom lens and a VCR, was used to record the whole combustion process, from which the wave velocity was determined by frame-by-frame analysis of the wave front.

Lower density pellets (30-50% theoretical) can be prepared from dry reactant powders by the following procedures: 1) make a mold (with shape desired) out of a material that is easily burnt off at high temperature, such as paper; 2) fill the mold with the reactant powders; 3) shake slightly to the height corresponding to the desired density; 4) place the mold inside a furnace heated at a pre-determined temperature for minimum time (e.g., 500° C. for 2 minute for cylindrical pellets with 2 gram mass and around 35% density. However, higher or lower temperature may be used for shorter or longer time for pellets with different mass and dimensions); and 5) retrieve the pellet by discarding the unburnt paper. Green pellets with complex shape and minimum possible density (loose pack density) can be obtained by this method. Examples of making tubular shape samples which can directly be used as filtering media are given later.

For slightly higher green density than loose packing, manual pressure is applied at step three above. Among the above four steps, step 4 is the critical step. There is an optimum combination of furnace temperature and time: too high temperature and/or too long time may lead to over-sintering the reactant powders making the ignition and self-combustion difficult; too low furnace temperature and/or too short time results in under-sintered reactant powders and such pellets are too fragile to be handled. For pellets with a mass of two grams and diameter 0.5 inches, the combination of 500° C. and 2 minutes was found to be adequate. However, other temperature/time combinations may also be used. Heat treatment described in step 4 generated a hardened shell on the pellet surface which actually caused a slight reduction in the exothermicity of the combustion reaction. The reacted samples also had a smoother surface and contained less large pores than those pellets reacted without heat treatment.

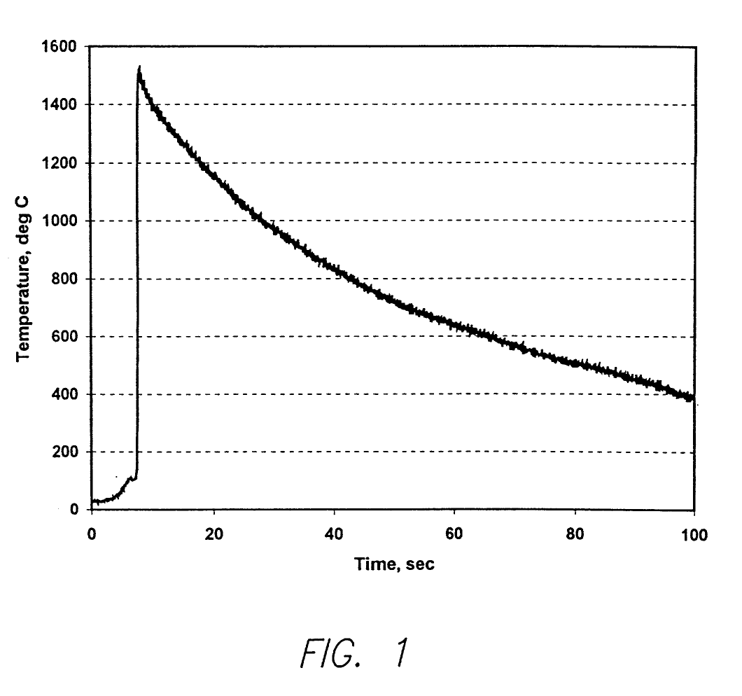

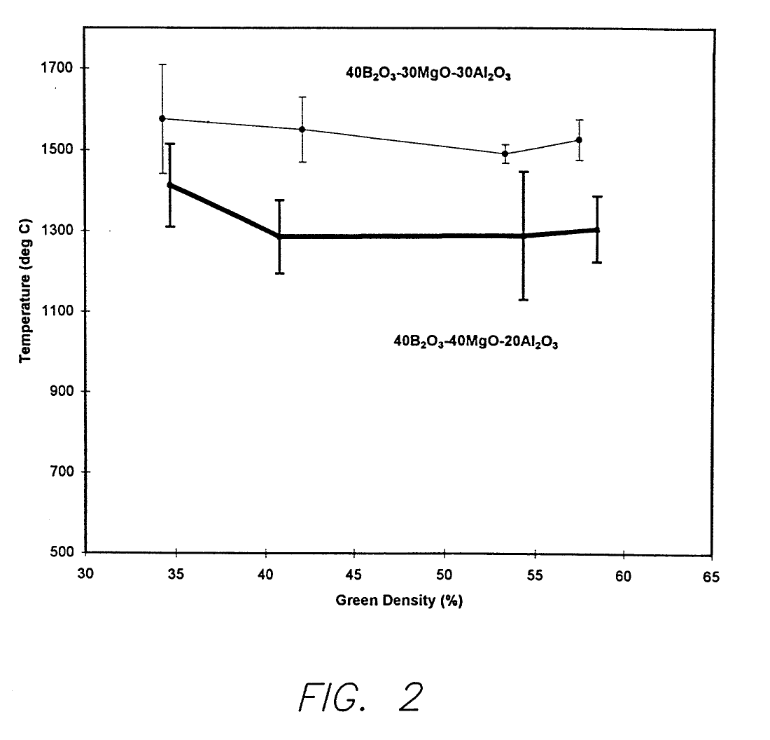

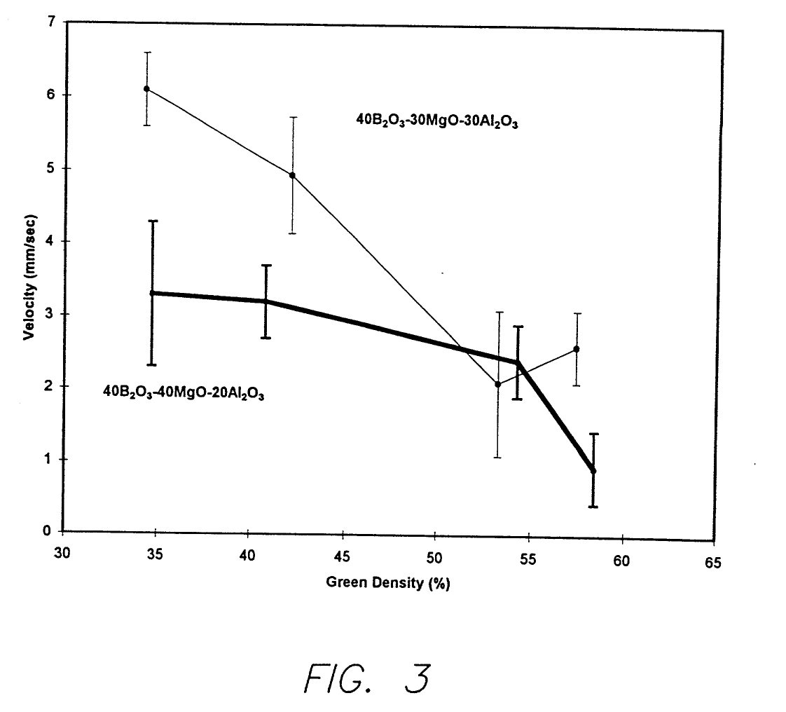

A typical temperature profile is shown in FIG. 1 for a pellet with a glass matrix of 40B₂O₃-35MgO-25Al₂O₃ (mol. %) and a green density of 34%. It can be divided into three portions. The first portion represents the temperature of the un-reacted part (room temperature), and the second portion represents the sudden temperature rise to the maximum (combustion Temperature, Tc) when the combustion wave passes through the location of the thermocouples. The third portion represents the cooling process of the glass melt. The effect of green density on the combustion temperature for two representative compositions is shown in FIG. 2. The effect of green density on the combustion wave for the same two representative compositions are shown in FIG. 3. While the combustion temperatures decreased slightly with the increase of green density, the combustion wave velocity decreased more drastically. More importantly, pellets with lower density were readily ignited with minimum pre-heating before combustion. Apparently, higher density pellets have higher thermal conductivity which increases heat loss by conduction. It was also found that higher combustion temperature and wave velocity for low density pellets enabled a more complete combustion reaction to take place, since it was observed that some pellets reacted from relatively high green density contain visible unmixed species, while those reacted from lower density contained much less unmixed species. This was found to be the case for most compositions, especially for the one with a glass matrix composition of 50B₂O₃-30MgO-20Al₂O₃. In fact, it was found that for this particular composition, the combustion waves were self-quenching for pellets with densities higher than 50% and the reacted part contained a lot of unmixed species (white in color) on the surface, while those pellets with 34% densities reacted to completion with much less unmixed species on their surfaces. According to Hirayama [1961], this composition is immiscible under normal conditions.

The combustion characteristics for samples that all had about 35% density but different compositions are summarized in Table 3. Those combustion reactions all proceeded to completion with planar, stable propagating wave characteristics. It was noted that the combustion temperatures were 200-500° C. lower than their corresponding adiabatic temperatures.

TABLE 3
Combustion Wave Velocity and Temperature (average) for
Low Density Pellets (35 ± 1%) with Different Matrix
Compositions (Heat Treatments: 500° C./2 minutes)

| Compositions (mol %) | Tc, ° C. | V, mm/s |
|---|---|---|
| 40 B₂O₃-40MgO-20 Al₂O₃ | 1456 | 4.6 |
| 50 B₂O₃-30MgO-20 Al₂O₃ | 1187 | 1.7 |
| 40 B₂O₃-45MgO-15 Al₂O₃ | 1454 | 3.3 |
| 40 B₂O₃-30MgO-30 Al₂O₃ | 1516 | 5.6 |
| 45 B₂O₃-40MgO-15 Al₂O₃ | 1401 | 2.2 |
| 45 B₂O₃-35MgO-20 Al₂O₃ | 1412 | 3.1 |
| 35 B₂O₃-45MgO-20 Al₂O₃ | 1510 | 5.5 |
| 40 B₂O₃-35MgO-25 Al₂O₃ | 1483 | 5.3 |
| 35 B₂O₃-40MgO-25 Al₂O₃ | 1508 | 5.7 |

Measurements of porosity of reacted samples by the Archimedes method using water revealed that the overall porosity of all samples after reaction was around 66-71% regardless of the compositions and densities of the green pellets (apparently, higher density pellets expanded more) and there was also little difference in apparent porosity (all were in the range of 52-58%). However, those samples reacted from low green density (˜35%) had a more uniform distribution of pores and the surfaces of these samples were much smoother than those reacted from high green density pellets (>50%).

The microstructures of reacted products were characterized by X-ray diffraction (XRD) and Optical and Scanning Electron Microscopy (SEM). Selected samples were cut with one half polished for optical microscope observations and a section of the other half crushed into powder for XRD analysis. Microstructures from the XRD and microscopic analysis are summarized in Table 4.

TABLE 4
Microstructures of Reacted Samples

| Samples | XRD | Microscope |
|---|---|---|
| 40 B₂O₃-40MgO-20 Al₂O₃ | TiB₂ + glass + crystallized | localized devitrification, mainly |
| | phases | glass matrix |
| 50 B₂O₃-30MgO-20 Al₂O₃ | TiB₂ + glass + crystallized | localized devitrification, mainly |
| | phases | glass matrix |
| 40 B₂O₃-45MgO-15 Al₂O₃ | TiB₂ + glass + crystalized phases | localized devitrification, mainly |
| | | glass matrix |
| 40 B₂O₃-30MgO-30 Al₂O₃ | TiB₂ + glass + crystalized phases | Extensive devitrification |
| | | everywhere |
| 45 B₂O₃-40MgO-15 Al₂O₃ | TiB₂ + glass | minimum devitrification, mainly |
| | | glass matrix |
| 45 B₂O₃-35MgO-20 Al₂O₃ | TiB₂ + glass + crystalized phases | localized devitrification, mainly |
| | | glass matrix |
| 35 B₂O₃-45MgO-20 Al₂O₃ | TiB₂ + glass + crystalized phases | localized devitrification, mainly |
| | | glass matrix |
| 40 B₂O₃-35MgO-25 Al₂O₃ | mainly TiB₂ + glass | glass matrix |
| 35 B₂O₃-40MgO-25 Al₂O₃ | TiB₂ + glass + crystalized phases | localized devitrification, mainly |
| | | glass matrix |

Samples with the matrix composition of 40B₂O₃-30MgO-30 Al₂O₃ do not form pure glass since it is outside the glass-forming region, as determined by Hirayama [1961]. This was confirmed by both the XRD and the optical microscope observations in the present work. However, samples with the matrix composition of 40B₂O₃-40MgO-20Al₂O₃ are supposed to be pure glass according to the same author, and this was found to be true for most areas of the polished sample, but localized devitrification was also observed in selected areas where small crystals were noticed. Crystallization peaks were also observed on XRD patterns for this composition. It was found that the only matrix composition that is pure glass is 40B₂O₃-35MgO-25Al₂O₃. The 45B₂O₃-40MgO-15Al₂O₃ also seems close to pure glass—it had minimum devitrification as revealed by XRD and optical microscopic examination. Other compositions were mostly glass matrix with slight devitrification in selected areas.

### EXAMPLES

### Example 1

Reactant powders were dry mixed in proportions corresponding to a glass matrix of 40B₂O₃-40MgO-20Al₂O₃ (mol. %) using ball milling in air. Cylindrical pellets were then pressed uniaxially to a green density of 53±2% of theoretical. The pellets were then ignited in a combustion chamber by resistance heating a W coil under inert Argon atmosphere. The average combustion temperatures (Tc) were 1360° C. and wave velocities were 2-6 mm/sec. X-ray diffraction (XRD) on powders crushed from the reacted pellets and microscopic observation on polished samples showed that the matrix was mainly glassy phase with slight devitrification in selected areas. In addition TiB₂ appeared as small particles with size around 0.5 μm. Average apparent porosity of reacted samples was 56±2%, and average overall porosity was 68±2%. All other compositions could also be prepared this way.

### Example 2

Reactant powders were dry mixed in proportions corresponding to a glass matrix of 40B₂O₃-30MgO-30Al₂O₃ (mol. %) using ball milling in air. Cylindrical pellets were then pressed uniaxially to a green density of 55±2% of theoretical. The pellets were then ignited in air without a combustion chamber by resistance heating a coil made from Kanthal wires. The average combustion temperatures (Tc) were around 1422° C. and wave velocities were 3-2 mm/sec. X-ray diffraction (XRD) on powders crushed from the reacted pellets and microscopic observation on polished samples showed that the matrix was devitrified extensively. In addition TiB₂ appeared as small particles with size around 0.5 μm. Average apparent porosity of reacted samples was 61±2%, and average overall porosity was 71±2%. All other compositions could also be prepared this way.

### Example 3

Reactant powders were dry mixed in proportions corresponding to a glass matrix of 40B₂O₃-45MgO-15Al₂O₃ (mol. %) using ball milling in air. Cylindrical pellets were then pressed uniaxially to a green density of 55±1% of theoretical. The pellets were then ignited in air without a combustion chamber by burning of an oxygen-propane torch. The average combustion temperatures (Tc) were 1354° C. and wave velocities were 2-4 mm/sec. X-ray diffraction (XRD) on powders crushed from the reacted pellets and microscopic observation on polished samples showed that the matrix was mainly glassy phase with slight devitrification in selected areas. In addition TiB₂ appeared as small particles with size around 0.5 μm. Average apparent porosity of reacted samples was 53±2%, and average overall porosity was 67±1%. All other compositions could also be prepared this way.

### Example 4

Reactant powders were dry mixed in proportions corresponding to a glass matrix of 50B₂O₃-30MgO-20Al₂O₃ (mol. %) using ball milling in air. Cylindrical pellets were then pressed uniaxially to a green density of 55±2% of theoretical. The pellets were then ignited in air by placing them inside a furnace pre-heated to 700° C. (simultaneous combustion) (any temperatures higher than 600° C. were acceptable). A combustion reaction started shortly. X-ray diffraction (XRD) on powders crushed from the reacted pellets and microscopic observation on polished samples showed that the matrix was mainly glassy phase with slight devitrification in selected areas. In addition TiB₂ appeared as small particles with size around 0.5 μm. Average apparent porosity of reacted samples was 52±2%, and average overall porosity was 64±2%. All other compositions could also be prepared this way.

### Example 5

Reactant powders were dry mixed in proportions corresponding to a glass matrix of 45B₂O₃-40MgO-15Al₂O₃ (mol. %) using ball milling in air. Cylindrical pellets with a green density of 34±2% of theoretical were then prepared using the method described for preparation of low density pellets, above. The pellets were then ignited in a combustion chamber by resistance heating a W coil under inert Argon atmosphere. The average combustion temperatures (Tc) were 1401° C. and wave velocities were 2.2 mm/sec. X-ray diffraction (XRD) on powders crushed from the reacted pellets and microscopic observation on polished samples showed that the matrix was mainly glassy phase with slight devitrification in selected areas. In addition TiB₂ phase appeared as small particles with size around 0.5 μm. Average apparent porosity of reacted samples was 54±2%, and average overall porosity was 68±2%. All other compositions could also be prepared this way.

### Example 6

Reactant powders were dry mixed in proportions corresponding to a glass matrix of 45B₂O₃-35MgO-20Al₂O₃ (mol. %) using ball milling in air. Cylindrical pellets with a green density of 34±2% of theoretical were prepared using the method described for preparation of lower density pellets, above. The pellets were then ignited in a combustion chamber by resistance heating a W coil under inert Argon atmosphere. The average combustion temperatures (Tc) were 1412° C. and wave velocities were 3.1 mm/sec. X-ray diffraction (XRD) on powders crushed from the reacted pellets and microscopic observation on polished samples showed that the matrix was mainly glassy phase with slight devitrification in selected areas. In addition TiB₂ phase appeared as small particles with the size around 0.5 μm. Average apparent porosity of reacted samples was 56±2%, and average overall porosity was 67±2%. All other compositions could also be prepared this way.

### Example 7

Reactant powders were dry mixed in proportions corresponding to a glass matrix of 35B₂O₃-45MgO-20Al₂O₃ (mol. %) using ball milling in air. Cylindrical tubular pellets (outside diameter of 0.75 inches and inside hole diameter of 0.5 inches) with a green density of 33±2% of theoretical were then prepared using the method described for preparation of lower density pellets, above. The pellets were then ignited in a combustion chamber by resistance heating a W coil under inert Argon atmosphere. The average combustion temperatures (Tc) were 1510° C. and wave velocities were 5.5 mm/sec. X-ray diffraction (XRD) on powders crushed from the reacted pellets and microscopic observation on polished samples showed that the matrix was mainly glassy phase with slight devitrification in selected areas. In addition TiB₂ appeared as small particles with size around 0.5 μm. Average apparent porosity of reacted samples was 54±2%, and average overall porosity was 68±2%. All other compositions could also be prepared this way.

### Example 8

Reactant powders were dry mixed in proportions corresponding to a glass matrix of 40B₂O₃-35MgO-25Al₂O₃(mol. %) using ball milling in air. Cylindrical tubular pellets (outside diameter of 0.75 inches and inside hole diameter of 0.5 inches) with a green density of 42±2% of theoretical were then prepared using the method described for preparation of lower density pellets, above. The pellets were then ignited in a combustion chamber by resistance heating a W coil under inert Argon atmosphere. The average combustion temperatures (Tc) were 1483° C. and wave velocities were 5.3 mm/sec. X-ray diffraction (XRD) on powders crushed from the reacted pellets and microscopic observation on polished samples showed that the matrix was pure glassy phase. In addition TiB₂ appeared as small particles with the size around 0.5 μm. Average apparent porosity of reacted samples was 52±2%, and average overall porosity was 64±2%. All other compositions could also be prepared this way.

### Example 9

Reactant powders were dry mixed in proportions corresponding to a glass matrix of 40B₂O₃-35MgO-25Al₂O₃(mol. %) using ball milling in air. Cylindrical tubular pellets (outside diameter of 0.75 inches and inside hole diameter of 0.5 inches) with a green density of 42±2% of theoretical were then prepared using the method described for preparation of lower density pellets, above. The pellets were then ignited in air using an oxygen-propane torch. The average combustion temperatures (Tc) were 1483° C. and wave velocities were 5.3 mm/sec. X-ray diffraction (XRD) on powders crushed from the reacted pellets and microscopic observation on polished samples showed that the matrix was pure glassy phase. In addition TiB₂ appeared as small particles with the size around 0.5 μm. Average apparent porosity of reacted samples was 52±2%, and average overall porosity was 64±2%. All other compositions could also be prepared this way.

### Example 10

Reactant powders were dry mixed in proportions corresponding to a glass matrix of 35B₂O₃-40MgO-25 Al₂O₃ (Mol. %) using ball milling in air. Cylindrical tubular pellets (outside diameter of 0.75 inches and inside hole diameter of 0.5 inches) with a green density of 34±2% of theoretical were then prepared using the method described for preparation of lower density pellets, above. The pellets were then ignited in a combustion chamber by resistance heating a W coil under inert Argon atmosphere. The average combustion temperatures (Tc) were 1508° C. and wave velocities were 5.7 mm/sec. X-ray diffraction (XRD) on powders crushed from the reacted pellets and microscopic observation on polished samples showed that the matrix was pure glassy phase. In addition TiB₂ appeared as small particles with the size around 0.5 μm. Average apparent porosity of reacted samples was 55±2%, and average overall porosity was 67±2%. All other compositions could also be prepared this way.

Glass (Al₂O₃—B₂O₃—MgO) ceramic (TiB₂) composites have been described with reference to a particular embodiment. Other modifications and enhancements can be made without departing from the spirit and scope of the claims that follow.

What is claimed is:

1. A porous composite consisting essentially of particles of TiB₂ dispersed in a matrix consisting essentially of Al₂O₃, B₂O₃ and MgO.

2. A porous composite as claimed in claim 1 in which said matrix is pure glass.

3. A porous composite as claimed in claim 1 in which said matrix is glass with partial devitrification.

4. A porous composite as claimed in claim 1 in which the size of the TiB₂ particles is less than 0.5 μm.

5. A porous composite as claimed in claim 1 which contains about 1-23 mol TiB₂, about 1-25 mol Al₂O₃, about 2-45 mol B₂O₃, and about 2-40 mol MgO.

6. A porous composite as claimed in claim 1 which contains about 15-20 wt. % TiB₂, about 20-35 wt. % mol Al₂O₃, about 30-45 wt. % B₂O₃, and about 10-25 wt. %. MgO.

7. A process of making a porous glass-ceramic composite comprising the steps of:
a. providing powdered TiO₂, B₂O₃, Al and Mg;
b. weighing the powders in the following mole ratio: αTiO₂: (α+χ)B₂O₃:2βAl: γMg, where β represents any finite number,
$$α = \frac{1}{5} ( 3 β + γ ) , \\ γ = β \frac{{f}_{m}}{{f}_{a}} , \\ and$$
$$χ = β \frac{{f}_{b}}{{f}_{a}} ;$$
c. mixing the powders dry, in air, in a ball mill;
d. forming the mixed powders into a green pellet uniaxially into density of 30-70% theoretical;
e. heat treating the green pellet;
f. igniting the heat treated pellet, whereby a reaction product of αTiB₂ particles in a matrix having the formula fₐAl₂O₃.f_{b}B₂O₃.fₘMgO is produced, where fₐ is the molar percentage of Al₂O₃ in said matrix, f_{b} is the molar percentage of B₂O₃ in said matrix and fₘ is the molar percentage of MgO in said matrix; and
g. shaping the said reaction product into desired shape when the temperature has dropped to about 600-700° C.

8. A process of making a porous glass-ceramic composite as claimed in claim 7 in which β is in the range from 10⁻³⁰⁰ to 10³⁰⁰.

9. A process of making a porous glass-ceramic composite as claimed in claim 7 in which the step of forming the mixed powders into a green pellet uniaxially into density of 30-70% theoretical comprises the steps of:
a. making a mold with desired shape out of a material that is easily burnt off at high temperature;
b. filling the mold with the mixed powders;
c. compacting the mixed powders to a height corresponding to a desired density;
d. placing the mold containing the compacted powders inside a furnace heated to an optimum, sintering temperature;
e. withdrawing the mold from the furnace; and
f. retrieving the pellet by discarding the mold.

10. A process of making a porous glass-ceramic composite as claimed in claim 9 in which the compacting step comprises shaking.

11. A process of making a porous glass-ceramic composite as claimed in claim 9 in which the compacting step comprises lightly pressing using a plunger.

12. A process of making a porous glass-ceramic composite as claimed in claim 7 in which the powders have a particle size of less than 45 μm.

13. A process of making a porous glass-ceramic composite as claimed in claim 7 in which ignition is performed by resistance heating a W coil in an inert atmosphere inside a reaction chamber.

14. A process of making a porous glass-ceramic composite as claimed in claim 7 in which ignition is performed by resistance heating a Kanthal-wire in air.

15. A process of making a porous glass-ceramic composite as claimed in claim 7 in which ignition is performed by burning of a regular torch in air.

16. A process of making a porous glass-ceramic composite as claimed in claim 7 in which ignition is performed by placing the pellets into a furnace previously heated to over 600 ° C.

17. A porous composite consisting essentially of α mol of TiB₂ particles dispersed in a matrix consisting essentially of fₐAl₂O₃, f_{b}B₂O₃ and fₘMgO in which fₐ is the molar percentage of Al₂O₃ in said matrix, f_{b} is the molar percentage of B₂O₃ in said matrix and fₘ is the molar percentage of MgO in said matrix and
$$α = \frac{1}{5} β ( 3 + \frac{{f}_{m}}{{f}_{a}} )$$
where β can be any finite number.

18. A porous composite as claimed in claim 17 in which said matrix is pure glass.

19. A porous composite as claimed in claim 17 in which said matrix is glass with partial devitrification.

20. A porous composite as claimed in claim 17 in which the size of the TiB₂ particles is 0.5 μm.

21. A porous composite as claimed in claim 17 in which α is about 1-23, fₐ is about 20-35 f_{b} is about 30-45 and fₘ is about 10-25.

22. A porous composite as claimed in claim 17 in which β is in the range from 10⁻³⁰⁰ to 10³⁰⁰.
